(19) United States
(12) Patent Application Publication
(10) Pub. No.: US 2025/0328138 A1
(43) Pub. Date: Oct. 23, 2025

(54) Adaptive Externalization of Robot Control

(71) Applicant: ABB Schweiz AG, Baden (CH)

(72) Inventors: Pietro Falco, Parete (IT); Aftab Ahmad, Västerås (SE); Polychronis Kontaxakis, Thessaloniki (GR); Ongjen Dobrijevic, Västerås (SE)

(73) Assignee: ABB Schweiz AG, Baden (CH)

(21) Appl. No.: 19/258,165

(22) Filed: Jul. 2, 2025

Related U.S. Application Data
(63) Continuation of application No. PCT/EP2023/050078, filed on Jan. 3, 2023.

(51) Int. Cl. G05D 1/227; B25J 5/00; G05D 1/226

(52) U.S. Cl. CPC G05D 1/2274; G05D 1/226; B25J 5/00

(57) ABSTRACT

A controller arrangement for controlling an industrial robot that includes a robot controller and a robot manipulator, the controller arrangement comprising: the robot controller; an external controller for the industrial robot; a wireless data link between the external controller and the industrial robot; and a quality of service (QOS) monitor configured to assign responsibility to the external controller while the QoS of the wireless data link is above a QoS threshold, and to the robot controller while the QoS is below the QoS threshold.

### CROSS-REFERENCE TO RELATED APPLICATIONS

The instant application claims priority to International Patent Application No. PCT/EP2023/050078, filed Jan. 3, 2023, which is incorporated herein in its entirety by reference.

### FIELD OF THE DISCLOSURE

The present disclosure generally relates to automation and, more particularly, to robotic control.

### BACKGROUND OF THE INVENTION

In automation applications, including factory automation, it is expected that an increasing share of the deployed field devices will be controlled and monitored over wireless links rather than wired connections. The use of wireless communication makes it easier to replace and/or reconfigure devices in an existing factory environment, it avoids the need to install and maintain cabling, and it could also be a decisive enabler for connecting densely clustered or otherwise inaccessible devices in a factory. Wireless control of mobile automation devices, such as mobile robots or automated guided vehicles (AGVs), is also advantageous in that the necessary computational capacity can be supplied by an external processor (e.g., cloud processing resource, edge processing resource) rather than an onboard processor. Such onboard processors are known to drain significant energy from the battery of the mobile automation device when solving computationally heavy tasks, so that frequent recharging is needed, which detracts from productivity.

Compared with a wired connection, however, a wireless link is inherently more exposed to disturbances, including atmospheric and meteorologic conditions, radio interference, as well as the presence of absorbing or reflective objects in the vicinity of the communication path. Such factors limit the transmission capacity of the wireless link and could at worst cause it to break down. The disturbances are difficult to predict and counter when the wireless link is maintained in a changing environment like a factory, and more so if it extends between moving communicating parties. The delivered transmission capacity of a wireless link may also vary significantly with the current network load, the distance to access point and depending on scheduling decision taken in the network.

US2015197010A1 discloses a method for evaluating signal quality metrics at one or more locations on an available path for a robotic device to a target location, and wherein a path to a target location and an access point switching plan for the robotic device are determined based on evaluated metrics. The evaluation of signal quality metrics may include comparing signal quality metrics associated with one or more locations to multiple signal quality thresholds, where one or more of these signal quality thresholds may include a minimum bandwidth threshold. The access point switching plan may comprise one or more switching events between multiple radio access technologies (RATs) at the corresponding boundaries. The path or access point switching plan can be determined based on comparing the costs associated with usage of multiple RATs. In particular, the path planning according to US2015197010A1 can be configured such that regions where signal quality is below a given threshold are avoided. To the extent that signal quality planning data is accurate, the wireless communication with the robotic device can be maintained without interruptions.

### BRIEF SUMMARY OF THE INVENTION

The present disclosure generally describes methods and devices for controlling an industrial robot, at least in part, over a wireless connection. According to some embodiments, these methods and devices are specifically adapted for motion planning of an industrial robot.

In one embodiment, the present disclosure describes systems and methods that externalize the controlling of an industrial robot such that the industrial robot remains under meaningful control through periods of fluctuations in the performance of a wireless link over which the externalized control acts. In particular, the industrial robot remains productive despite a temporary drop in wireless link performance. The disclosure further describes improved ways of monitoring the performance of the wireless link at runtime, a controller arrangement for controlling an industrial robot, a robot navigation arrangement for controlling a mobile robot, and ways to externalize the navigation of the mobile robot as well as the control of a robot arm mounted thereon.

In a first aspect of the present disclosure, there is provided a controller arrangement for controlling an industrial robot, which may be a non-propelled robot (e.g., stationary robot, portable robot) or a mobile robot (e.g., AMR, AGV, mobile manipulator). The industrial robot comprises a robot controller and a robot manipulator. The controller arrangement comprises the robot controller; an external controller for the industrial robot; a wireless data link between the external controller and the industrial robot; and a quality of service (QOS) monitor. The QoS monitor is configured to assign responsibility to the external controller while the QoS of the wireless data link is above a QoS threshold, and to the robot controller while the QoS is below the QoS threshold.

It is understood that the robot controller and the external controller are, in principle, configured for the same control task (e.g., work planning, motion planning), and they can, therefore, replace one another. One advantage of using the external controller rather than the robot controller is that the robot's energy resources are conserved. Another advantage is that the external controller may have more extensive processing resources at its disposal and can solve the control task more thoroughly than the robot controller, e.g., with a greater planning horizon or a larger search space. A still further advantage is that the external controller can use a processing resource that is shared with other applications, so that the shared processing resource is more evenly loaded over time. The controller arrangement according to the first aspect combines these advantages with an adequate robustness to fluctuations of the wireless data link, namely, by assigning the responsibility to the robot controller when the monitored QoS of the wireless data link drops below a threshold.

In some embodiments, the QoS monitor includes at least one component which is external to the industrial robot. For example, the QoS monitor may be implemented in a networked processing resource or an edge-cloud processing resource. Under either of these architectural options, it becomes possible to monitor the QoS by higher-level network indicators, such as data throughput, packet loss rate, packet loss burstiness, transmission reliability, latency and/or latency variation, which are in some respects superior to radio measurements.

In specific further developments of these embodiments, the QoS monitor may consist of one external component and one onboard component, wherein the external component is responsible for QoS monitoring in normal conditions (e.g., when the external controller is responsible) and the onboard component steps in while the QoS is poor (e.g., while the onboard controller is responsible) to detect when the wireless data link recovers. As used herein, an onboard component may refer to a component that is co-located with the industrial robot or one that is carried in the robot manipulator or travels with it.

In some embodiments, where the industrial robot is a mobile robot (or autonomous robot, or self-propelled robot), the robot controller is an onboard motion planner, and the external controller is an external motion planner. Specifically, the controller arrangement according to these embodiments may be configured to control movements of an arm (or tool) of the mobile robot and to control the horizontal motion of the mobile robot's base.

In a second aspect of the present disclosure, there is provided a method for controlling an industrial robot, which comprises a robot controller and a robot manipulator, the method comprising: maintaining a wireless data link between a controller which is external to the industrial robot on the one hand and the industrial robot on the other hand; controlling the industrial robot using the external controller; and monitoring a quality of service (QOS) of the wireless data link. If it is found that the monitored QoS drops below a QoS threshold, the industrial robot is temporarily controlled using the robot controller of the industrial robot rather than the external controller.

The method according to the second aspect generally shares the advantages of the controller arrangement according to the first aspect, and it can be implemented with a corresponding degree of technical variation.

This disclosure further relates to a computer program containing instructions for causing a computer, or the controller arrangement, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

In the present disclosure, the term “industrial robot” shall include robots of a similar basic design even if they are also suitable for—or in fact adapted for—a different purpose, such as cleaning, table waiting, entertainment, healthcare etc., and even if they are marketed as service robots.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE SEVERAL VIEWS OF THE DRAWING(S)

FIG. 1 is a schematic of a work site in which a plurality of connected mobile robots under partially externalized control circulate, in accordance with the disclosure.

FIG. 2 is a flowchart of a control method in accordance with the disclosure.

FIG. 3 is a diagram of a factory environment where a plurality of stationary industrial robots is installed, wherein the robots are controlled externally, at least during certain periods, in accordance with the disclosure.

### DETAILED DESCRIPTION OF THE INVENTION

Certain aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

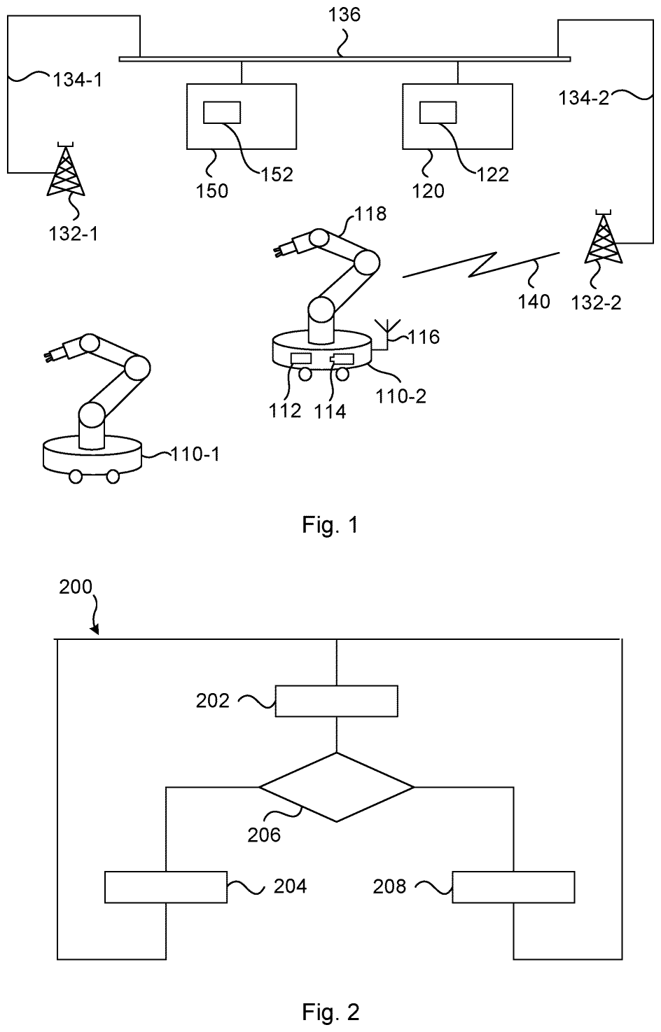

FIG. 1 shows a worksite where a plurality of industrial robots 110 circulate. Here, the industrial robots 110 are mobile robots, such as autonomous mobile robots (AMRs), autonomous guided vehicles (AGVs) or mobile manipulators. A mobile manipulator is understood to be a mobile base with one or more robot arms mounted on the mobile base. The worksite may for example be a factory, logistics facility, energy generation plant or a recycling plant. For the reasons presented above, the worksite may also be a dwelling, restaurant, school, hospital or another non-industrial environment. The mobile robots 110 are self-propelled and steerable, and they are adapted to move horizontally on a substrate by means of wheels, continuous tracks or the like. The mobile robots 110 further carry robot arms 118 (or robot manipulators) adapted for an industrial task, such as processing, cutting, painting, welding, thermal treatment, material handling, sorting, packaging, inspection and measuring. A mobile robot 110 may further include a portable energy source, such as a battery 114. The battery 114 may be associated with an onboard charging device or adapted for offboard charging, or the battery 114 may be replaceable at runtime.

Each robot 110 is equipped with a wireless interface 116, which is operable to set up and maintain a wireless data link 140 to an access point 132. The access point may, together with optional further access points, belong to a radio access network installed on the worksite. The wireless interface 116 of the robot 110 can act as a (mobile) station of Wi-Fi™ (IEEE 802.11 series), a field device of WIA-FA, or a user equipment (UE) of a cellular network such as 3GPP New Radio (‘5G’). Correspondingly, the access point 132 can be the access point of Wi-Fi™, the access device of WIA-FA, or a base station (NB, ENB, gNB) of the cellular network. The robots 110 are able to connect to different access points 132 as they move between different areas of the worksite, which may be facilitated by per se known handoff techniques. The radio access network may be associated with a core network 136 which connects to each of the access points 132, optionally via connection lines 134, and performs core network functionalities, such as connection aggregation, authentication, switching, connection control, service invocation, and it may operate gateways towards other networks. Additional devices may be connected to the core network 136, including generic networked (‘cloud’) processing resources 120 and edge processing resources 150. In broad terms, cloud processing resources are used for location-agnostic resource allocation, whereas edge processing resources are used for proximity-aware resource allocation. This is to say, the edge processing resources 150 are located, with respect to the topology of the core network 136 and/or radio access network, such that the intended user is expected to enjoy a reasonable QoS in normal conditions, e.g., the connection between the intended user and the edge processing resources 150 normally fulfils a minimum throughput, a maximum latency, or similar requirements. The fulfilment of such QoS requirements in normal conditions can be achieved by placing the edge processing resources 150 suitably and/or by configuring network parameters related to routing, scheduling, resource allocation and traffic prioritization.

The access points 132 may be implemented in dedicated radio hardware, sensibly devoid of duties that are unrelated to the running of the radio access network, or in commodity hardware. The dedicated radio hardware may be owned or controlled by a network service provider, whereas the commodity hardware may be owned or controlled by the same entity as the worksite, e.g., a factory owner. The commodity hardware may be generic and/or multifunctional hardware, which offers computational capacity in addition to the duties related to the radio access network. The computational capacity may be offered in the form of edge processing resources 150. A time-sharing scheme may be in place, wherein a greater percentage of the computational capacity of the hardware is made available as edge processing resources at such times when the load on the radio access network is lower. Accordingly, as an alternative to the localization according to FIG. 1, the edge processing resources 150 may alternatively be co-located with a component of one of the access points 132 and they may be an integral part thereof. The edge processing resources 150 may be located on the same premises as the worksite.

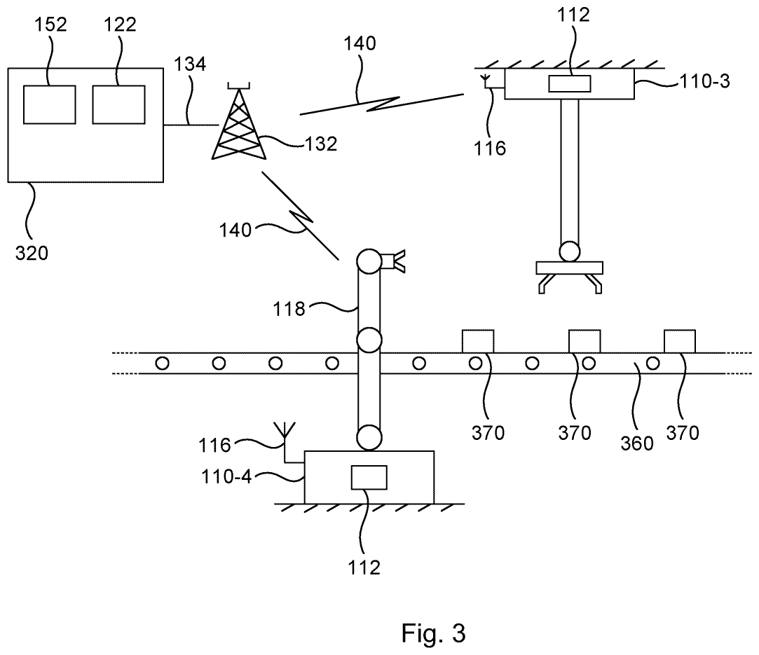

FIG. 3 shows a further one of the intended use cases, namely, a factory environment in which two stationary industrial robots 110 operate. Each of the industrial robots 110 is stationary in the sense that it is not equipped with a propulsion system for horizontal movement or for moving the industrial robot 110 in its entirety. This is to say, while the industrial robot 110 can perform relative movements between a tool or arm 118 relative to its base or frame, it is not configured for displacing itself. For purposes of the present disclosure, an industrial robot 110 is qualified as stationary even though it is not necessarily attached to a building part or a fixed support structure in the factory, and even though it is not immobilized by other means.

As FIG. 3 shows, the factory environment includes one suspended material-handling robot 110-3 configured to lift workpieces 370 traveling on a conveyor 360, and one floor-located robot 110-4 equipped with an arm 118 adapted for grasping and manipulating said workpieces 370. Each of the industrial robots 110-3, 110-4, similarly to those in FIG. 1, is equipped with a wireless interface 116, which is operable to set up and maintain a wireless data link 140 to an access point 132 using cellular, non-cellular or other wireless technology. The access point 132 is in communication with processing circuitry 320. The processing circuitry 320 may be provided in an edge server or a cloud server.

For each of the robots 110 in FIGS. 1 and 3, the movement of the arm 118 or the horizontal motion of the base, or the movement of both the arm 118 and the base, is controlled by a control algorithm. In implementations, it is customary to use a somewhat higher frequency for sending motion references relating to the arm 118 (e.g., 250 Hz) than for sending motion references relating to the base (e.g., 20 Hz).

Each of the industrial robots 110 may be modeled as a combination of a robot controller 112 and a robot manipulator. The robot manipulator may be identified as the entirety of the robot 110 except for the robot controller 112. Alternatively, the robot manipulator may be identified as the robot 110 except for the robot controller 112 and the wireless interface 116. Further alternatively, the robot controller is considered to include also drive circuitry, such as power electronics configured to provide information-carrying and/or energy-carrying electric signals to be supplied to actuators in the robot manipulator. In the examples of FIGS. 1 and 3, the robot controllers 112 are integral parts of the robot manipulators. In general, industrial robots, the robot controller 112 is at least co-located with the robot manipulator, in the sense that a reliable wired or wireless connection can be maintained therebetween. The wired or wireless connection may be reliable in the sense of having deterministic characteristics, such as acceptable delay, latency, throughput, error rate etc. A robot manipulator and a robot controller 112 may be in a one-to-one relationship; alternatively, to enable load-sharing, redundancy and similar benefits, multiple robot manipulators share a common robot controller and/or one robot controller can be alternatingly controller by multiple robot controllers.

The control algorithm executes a robot program with the overreaching purpose of carrying out an industrial task or service task of the type exemplified and discussed above, and subject to additional requirements. The scope of the control algorithm may include work planning or navigation, or both. The additional requirements may include speed constraints, safety constraints, loading constraints, motion constraints, as well as caps or minimality constraints on consumption of energy, paint, glue and other consumables. While some of the additional requirements could be enforced statically (e.g., a motion constraint forbidding entry into a specific area of the worksite), others may need to be enforced dynamically in dependence of the condition prevailing. Such conditions could include the presence of people and objects on the worksite, measurable physical or chemical conditions, states of technical machinery, the supply of necessary raw materials, the progress of earlier or parallel logistics or work processes, etc.

Just like the control algorithm may have to respect static and dynamic additional requirements, the control algorithm itself can be characterized, with respect to the robot 110, as either an open-loop or closed-loop algorithm. More precisely, if each robot 110 is abstractly modelled as an aggregate of sensors and actuators, a closed-loop algorithm may be one that determines the control signals to be fed to the actuators on the basis of measurement signals from the sensors, according to configured control laws and in such manner as to progress the execution of the robot program. An open-loop control algorithm instead begins the execution of the robot program at a suitable point in time (e.g., when earlier or parallel logistics or work processes have progressed sufficiently) by feeding control signals to the actuators, and continues the execution unless an instruction in the robot program is found that would violate a motion constraint, a safety requirement or the like, or unless a safety warning, technical alert or similar exceptional information is received. The open-loop control algorithm does not necessarily read any measurement signals. In particular, the control algorithm may delegate some aspects of the control of the industrial robot 110 to subsystems therein. For example, an integrated motor drive which executes a movement request will normally operate in response to feedback from position sensors in the drive, e.g., for verifying that an applied drive current achieves the requested movement as expected, wherein the feedback from the position sensors need not be shared with the control algorithm unless a serious error occurs.

A systematic approach to the robot control problem is to formulate and solve an optimal control problem (OCP). For this purpose, the industrial robot 110 is modeled as a linear dynamical system

$$\{ \begin{matrix}{x}^{′} ( t ) = A x ( t ) + B u ( t ) \\ y ( t ) = C x ( t ) + D u ( t )\end{matrix}$$

where x is a state vector (the angles of the joints of a multi-joint robot 110 could be some states), u is a control signal (a motion request to an integrated motor drive could be one of these), y is an output variable (or observable), and A, B, C, D are matrices. If the robot 110 is modeled as a time-invariant system, the matrices A, B, C, D are constant with respect to time. In more sophisticated system models, one or more of the matrices A, B, C, D can assume alternative values depending on current settings of the system, such as depending on whether or not an arm 118 of the robot 110 is lifting a load (e.g., A=A_{loaded} or A=A_{unloaded}), to reflect the changing dynamics. Alternatively, the robot 110 can be modeled as a nonlinear dynamical system

$$\{ \begin{matrix}{x}^{′} ( t ) = f ( x ( t ) , u ( t ) , t ) \\ y ( t ) = g ( x ( t ) , u ( t ) , t )\end{matrix}$$

The time dependence of functions f, g may be absent if the modeled nonlinear dynamical system is time-invariant. An overreaching responsibility of the control algorithm is to provide a scalar- or vector-valued control signal u which causes the controlled robot 110 to execute the robot program in the time interval [0, Tₕ]. This can be formulated, for a linear dynamical model, as an OCP where a utility functional/is to be maximized subject to the system dynamics and various further constraints C1, C2 . . . .

$$\begin{matrix}{max}_{u} & J ( x , u , [ 0 , {T}_{h} ] ) \\ \text{s.t.} & {x}^{′} ( t ) = A x ( t ) + B u ( t ) \\ & C 1 , C 2 , …\end{matrix} \qquad ( 1 )$$

The maximization is performed over the set of admissible control signals of the form

$$u = [ \begin{matrix}u ( 0 ) & u ( Δ t ) & u ( 2 Δ t ) & … & u ( {T}_{h} )\end{matrix} ] , \qquad ( 2 )$$

where Δt denotes a time step, and each component u(nΔt), n∈N, has the same dimension as the control signal. Similarly,

$$x = [ \begin{matrix}x ( 0 ) & x ( Δ t ) & x ( 2 Δ t ) & … & x ( {T}_{h} )\end{matrix} ] .$$

In a continuous-time representation, the control signal may be written

$$u = \{ u ( t ) : 0 \leq t \leq {T}_{h} \} .$$

The further constraints may be equality or inequality constraints, such as

$$\begin{matrix}C 1 : Ku \leq L , \\ C 2 : Mu = N ,\end{matrix}$$

where K, L, M, N are constant matrices. Two inequality constraints may be used to limit the control signal u to an acceptable range defined by actuator limits: u≤u(t)≤ū. The exact definition of the utility functional J is not essential to the present invention. By way of example, the utility functional J may include a term representing the degree of fulfilling the programmed movements in the time interval minus the cost of applying a particular control signal to the system and minus the cost of maintaining the robot 110 in a particular state (e.g., efficiency variations, thermal dissipation, mechanical wear).

In some embodiments, a programmed sequence of robot movements

$${x}_{0} = [ \begin{matrix}{x}_{0} ( 0 ) & {x}_{0} ( Δ t ) & {x}_{0} ( 2 Δ t ) & … & {x}_{0} ( {T}_{h} )\end{matrix} ] ,$$

determined and inserted into an OCP to be solved, wherein the OCP is to find a control signal u that causes the robot 110 to mimic the desired movement sequence. For example, the OCP (1) can be specialized into a minimization of an objective function that includes a term proportional to a norm of a difference between the programmed robot-movement sequence x₀ and the actual movement sequence x, such as:

$$\begin{matrix}{min}_{u} {‖ {x}_{0} - x ‖}_{p} & + … \\ \text{s.t.} & {x}^{′} ( t ) = A x ( t ) + B u ( t ) \\ & C 1 , C 2 , …\end{matrix} \qquad ( 3 )$$

where ∥·∥ₚ is a L^{p} or [symbol] norm with p≥1 on the time interval [0, Tₕ]. The length Tₕ may be described as the planning horizon of the control algorithm. Alternatively, the programmed sequence of robot movements can be expressed in terms of the output variable y, wherein the objective function contains a term ∥yₒ−y∥ₚ to be minimized.

The OCPs according to either formulation (1) or (3) may be solved by a direct solution formula or by executing an iterative or non-iterative numerical solver configured to produce an approximate solution. The solver may for example be an active-set (AS) method, an interior-point method (IP), alternating direction method of multipliers (ADMM), successive linear programming (SLP), sequential quadratic programming (SQP), sequential linear-quadratic programming (SLQP) and/or a reduced-gradient (RG) method. Some of these solvers are adapted for the case where the objective function is a quadratic function. The solution to the OCP may be applied in a receding horizon control scheme, as described in methods for model predictive control (MPC). For the robot navigation specifically, a grid-based algorithm or potential-field algorithm can be used.

Common to most of these options, the computational effort has a strong dependence on the planning horizon Tₕ, which is normally a configurable variable. The use of a relatively longer planning horizon Tₕ in the control algorithm, however, is likely to deliver a solution that is more foresightful or closer to the global optimum. The use of a relatively longer planning horizon Tₕ may correspond to finding the solution in a correspondingly larger search space. This is immediate from the example in equation (2) above, where Tₕ determines the number of components of the vector u and thus (exponentially) the cardinality of the search space. It is appreciated that the solution does not necessarily have to be found by an unrestricted search in the full search space, namely, since efficient heuristics for excluding irrelevant parts of the search space from consideration are known.

Control algorithms can be stateful or stateless. Such control algorithms that simulate the industrial robot 110 using a dynamical system model, including OCP algorithms, are inherently stateful. The state variables of an OCP algorithm may correspond to states of the dynamical system. Closed-loop control algorithms of the proportional-integral, proportional-derivative and proportional-integral-derivative (PI, PD, PID) types are stateful as well, as they effectuate a control law that depends on a history of a sensed variable; the history of the sensed variable may form part of a state of the control algorithm. Even open-loop control algorithms are stateful in the sense that they will behave differently depending on how far they have progressed in the robot program; the execution point in the robot program may be regarded as a state variable of the control algorithm.

A control algorithm of the type discussed herein can be executed in a robot controller 112 of the industrial robot 110 (e.g., carried therein) as well as in an external controller 122. As illustrated in FIGS. 1 and 3, the external controller 122 can be implemented in networked processing resources 120, 320 of any suitable type, wherein the sensor signals and actuator signals are then conveyed in the upward and downward direction of the wireless data link 140, respectively. The robot controller 112 may be powered by a battery 114, particularly in a mobile robot, and thus has limited energy resources at its disposal between charging events. The inventors foresee that the responsibility for controlling the industrial robot 110 is to be assigned, depending on the current quality of service (QOS) of the wireless link 140, either to the robot controller 112 or the external controller 122. At times of poor QoS, the robot controller 112 is generally preferred, and then the responsibility reverts to the external controller 122 once the QoS is found to (or expected to) have recovered.

In some embodiments, the control algorithm executing in the robot controller 112 can be a replica of a main control algorithm executing in the external controller 122. The replica may be exact or simplified. A simplified replica of the main control algorithm may be configured with one or more simplifying settings, such as a less ambitious value of one or more meta parameters. For example, the simplified replica may have a shorter planning horizon, which may translate into a smaller search space, but otherwise be of the same type or have the same structure as the main control algorithm. Types of algorithms suitable for use both in the robot controller 112 and the external controller 122 include model-predictive control (MPC), grid-based algorithms, probabilistic algorithms and optimization algorithms. Examples include the rapidly exploring random tree (RRT) algorithm and the probabilistic roadmap (PRM) algorithm.

In other embodiments, the main control algorithm executing in the external controller 122 is of a different type than the control algorithm executing in the robot controller 112. For example, if the external controller 122 performs robot navigation by executing an MPC algorithm, a grid-based algorithm, a probabilistic algorithm or an optimization algorithm, the robot controller 112 may use a potential-field algorithm for the same purpose.

In embodiments targeting mobile robots 110, a still further difference between the main control algorithm executing in the external controller 122 and the control algorithm executing in the robot controller 112 may reside in the fact that the external controller (external motion planner) 122 is configured to perform coordinated motion planning for a plurality of mobile robots 110. For coordinated motion planning there exist a multitude of scheduling algorithms and conflict-resolution algorithms which can be used here, including linear search combined with scoring (cost/reward function), various types of best-first search, graph-traversal methods, path-finding methods, A* search and similar algorithms. The coordinated motion planning is generally more efficient as conflicts can be resolved at a higher decision level rather than by executing negotiations protocols between the mobile robots 110, which could be time-consuming. In these embodiments, when the QoS of the wireless data link 140 drops below a QoS threshold for one of the mobile robots 110, the responsibility is handed over to the mobile robot's 110 own robot controller (onboard motion planner) 112 and the external controller 122 is notified that the mobile robot 110 is no longer part of the coordinated motion planning. The external controller 122 may react by treating the mobile robot 110, until further notice, as a generic traffic participant over which it has no control. The robot controller 112 for its part may apply similar generic navigation rules, such as collision avoidance, observance of pre-agreed yield rules, obstacle detection and the like, until the QoS of the wireless data link 140 is restored.

In some embodiments, the replica in the robot controller 112 executes in parallel with the main control algorithm regardless of whether it is controlling the industrial robot 110 or not. This is particularly useful when the control algorithm is stateful. This way, when the external controller 122 is controlling the industrial robot 110, the robot controller 112—similar to a hot standby unit—will not influence the operation of the industrial robot 110 but will maintain its internal state up to date, so that it is ready to step in for the external controller 122 on short notice.

A stop-and-go approach may, in other embodiments, be a useful alternative to the hot standby approach. According to this approach, the main control algorithm's replica in the robot controller 112 does not execute while the external controller 122 oversees the controlling of the industrial robot 110, but it receives copies of relevant state variables of the main control algorithm periodically or in response to predefined events. An observation that the QoS of the wireless data link 140 sinks below a predefined level and/or that it sinks faster than a predefined rate of change may trigger an operation where the main control algorithm's state variables are copied into the replica, to prepare a smooth handoff to the robot controller 112.

The robot controller 112, the external controller 122 and an associated QoS monitor 152 can be said to form a controller arrangement. The QoS monitor (or QoS analyzer) 152 is configured to assign the responsibility to the robot controller 112 or the external controller 122 depending on the current QoS of the wireless link 140 between the external controller and the industrial robot 110. The responsibility is re-assigned when the QoS changes. The switching may be governed by a QoS threshold, with an optional hysteresis to avoid undesirable ping-pong behaviors.

The QoS monitor 152 may be configured to estimate the QoS in terms of data throughput, bandwidth, packet loss rate, packet loss burstiness, transmission reliability, latency and/or latency variation. The QoS may be monitored as a weighted sum of a number of these quantities, and the QoS threshold may be expressed in terms of this weighted sum. Alternatively, the QoS monitor 152 may include a machine-learning model (or artificial intelligence model, such as an artificial neural network) trained to determine suitable switching points between internal control by the (onboard) robot controller 112 and external control, i.e. when the responsibility is to be reassigned, on the basis of operational variables of the radio access network to which the access points 132 belong.

In some embodiments, the QoS monitor 152 includes at least one component which is external to the industrial robot. For example, the QoS monitor 152 may be implemented in an external processing resource, such as a networked (cloud) processing resource 120 or an edge processing resource 150, as described above. Especially, the QoS monitor 152 may be implemented in a processing resource which is associated with the radio access network. By this placement, the QoS monitor 152 can estimate the QoS of the wireless data link 140 indirectly by relying on higher-level network indicators, such as data throughput, packet loss rate, packet loss burstiness, transmission reliability, latency and/or latency variation, which are in some respects superior to direct radio measurements.

In such embodiments where the radio access technology is Wi-Fi™, the QoS monitor 152 can be integrated in or associated with a so-called WLAN controller. A WLAN controller may generally be configured to manage the wireless network access points 132 through changing network demands to assist wireless devices while connecting to the Wi-Fi™ network. A WLAN controller will have access to key performance indicators of the Wi-Fi™ network, including the status of the access points 132, and will be able to make accurate estimations of the QoS of the wireless data link 140. In embodiments where the QoS monitor 152 is associated with the WLAN controller, the WLAN controller may be caused to expose—over a suitable interface—several of the momentary performance indicators to the QoS monitor 152.

In specific further developments of these embodiments, the QoS monitor 152 may be distributed in the sense that it consists of one external component (e.g., in edge processing resources 150) and one onboard component carried in or co-located with the industrial robot 110. From these, the external component is configured to monitor the QoS in normal conditions (e.g., when the external controller 122 is responsible for controlling the industrial robot 110) whereas the onboard component steps in while the QoS has been found to be poor; this latter condition may correspond to the periods when the robot controller 112 is responsible. A benefit of the distributed implementation of the QoS monitor 152 is that when the responsibility has been reassigned to the robot controller 112 due to interference, signal attenuation or the like, the fact that the radio conditions have improved is likely to be noticed by the onboard component of the QoS monitor 152 earlier than the above-mentioned higher-level network indicators have gone back to normal. This will contribute to smooth and timely resumption of the control by the external controller 122.

To summarize, the embodiments herein provide several options for how to trigger the reassigning of the responsibility back to the external controller 122 when the QoS, after having dropped below the QoS threshold, has recovered or is deemed to have recovered. It is appreciated that it may occur that the transmission of data (and payload data in particular) on the wireless data link 140 is suspended at this point until it is confirmed that the cause of the QoS drop has been removed. These options include:
a. An external component of the QoS monitor 152 continues to send pings or keep-alive data to the industrial robot 110 even after the assignment of the responsibility to the robot controller 112, so that the external component can compute one or more of the higher-level network indicators.
b. A timer of a predetermined duration is started, and when the timer expires the responsibility is reassigned back to the external controller 122. If it turns out that this reassigning was premature—i.e., the QoS of the wireless data link 140 is still poor—the robot controller 112 steps in.
c. An onboard component (see above) of the QoS monitor performs direct radio measurements. If it is found that the QoS drop was due to poor radio conditions, it may be assumed that the QoS of the wireless data link 140 can be improved when the radio conditions recover. Similarly, if the wireless data link 140 broke down due to the worsening radio conditions, the link can potentially be reestablished as soon as the radio conditions are back to normal. Accordingly, the onboard component of the QoS monitor attempts to detect when the radio conditions have recovered, and it then notifies the external component of the QoS monitor. The external component of the QoS monitor may react by reassigning the responsibility to the external controller 122.

It is noted that option b) is simple to implement but might operate less stably, e.g., it could be prone to interruptions. It is therefore suitable for use cases where unexpensive or unsensitive workpieces are at stake, or where a temporary interruption of the industrial robot's 110 productive operation can be tolerated.

A method 200 for controlling an industrial robot 110, at least in part by external means, will now be described with reference to the flowchart in FIG. 2. The method 200 may be implemented by a general-purpose processor with access to QoS-related information and with authority to assign the responsibility for controlling the industrial robot 110 to an external controller 122 and a robot controller 112 in the industrial robot 110. The method 200 may for example be performed by a component of a device acting as QoS monitor in the above-described sense. In particular, it may be implemented in edge processing resources 150 or in a WLAN controller associated with an access point.

The execution of the method 200 may start at an arbitrary point in the flow depicted in FIG. 2. For example, it is assumed that the execution begins at the top level of the flowchart, so that a step 202 is the initial one. The step 202 refers to a condition where a wireless data link 140 is maintained between the industrial robot 110 and an external controller 122. This includes establishing the wireless data link 140 if it does not yet exist at the beginning of the method 200. Likewise, if the wireless data link 140 has been out of order, as evidenced by a detected drop of QoS below a QoS threshold, the wireless data link 140 may have to be established anew. In the step 202, further, if the industrial robot 110 is in operation, it is being controlled either by the external controller 122 or—if the QoS has been recently found to be below the QoS threshold—by the robot controller 112.

At a decision step 206, the QoS of the wireless data link 140 is monitored, and it is determined whether the QoS is above or below a QoS threshold. The QoS threshold may be a configurable value, which a system owner can set in view of various expectations on the industrial robot 110, including that the industrial robot 110 shall operate reliably, with a low probability of interruptions; that the industrial robot 110 shall use foresightful work planning or motion planning with a sufficient planning horizon; and that the industrial robot 110 shall operate safely, without relying on a weak wireless data link 140.

The QoS threshold may refer to a momentary QOS value or to an aggregated QoS value, such as a moving average of the QoS. Further, the QoS threshold may refer to a history of past QoS values with a fixed duration, wherein it is required that the QoS must have been above a threshold value for the entirety of this fixed-duration history. Further, the QoS threshold according to one of these options may include a hysteresis. As seen above, the QoS may include data throughput, bandwidth, packet loss rate, packet loss burstiness, transmission reliability, latency, latency variation or combinations of these.

If it is decided that the QoS is below the QoS threshold, the industrial robot 110 is controlled using the robot controller 112 associated therewith. This condition corresponds to step 208. The assignment of the control responsibility stays with the robot controller 112 temporarily, in the sense that the control responsibility is returned to the more powerful and/or more economical external controller 122 when it has been detected that the QoS has risen above the QoS threshold again. This detection may be the outcome of a subsequent execution of step 206.

If instead it was found in step 206 that the QoS is above the QoS threshold, the execution flow continues to step 204 in which the responsibility for controlling the industrial robot 110 is assigned to (or remains with) the external controller 122. This is prudent because the QoS has been found to be acceptably high, so that the wireless data link 140 can be trusted.

As seen in FIG. 2, the execution of the method 200 loops back from step 204 or step 208 to step 202. The decision step 206 is repeated on the basis of a more recent value of the monitored QoS. The decision step 206 may be repeated after a predetermined time delay has elapsed, so that the responsibility for controlling the industrial robot 110 is not reassigned too frequently.

In an important special case, the industrial robot 110 is a mobile robot, and the controlling (steps 204, 208) thereof includes motion planning. Motion planning includes determining suitable, generally horizontal movements of a base of the mobile robot.

In some embodiments of the method 200, the monitoring of the QoS and related decision-making (step 206) are performed by means of a machine-learning model trained to determine suitable switching points between internal and external control, i.e., when the responsibility is to be reassigned.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A controller arrangement for controlling an industrial robot that includes a robot controller and a robot manipulator, the controller arrangement comprising:
the robot controller;
an external controller for the industrial robot;
a wireless data link disposed between the external controller and the industrial robot; and
a quality of service (QOS) monitor configured to assign responsibility to the external controller while the QoS of the wireless data link is above a QoS threshold, and to assign responsibility to the robot controller while the QoS is below the QoS threshold;
wherein the QoS monitor includes a component that is external to the industrial robot.

2. The controller arrangement of claim 1, wherein the QoS monitor further includes a further component that is carried in the mobile robot.

3. The controller arrangement of claim 1, wherein the QoS monitor is implemented at least in part in a networked processing resource.

4. The controller arrangement of claim 1, wherein the QoS monitor is implemented at least in part in an edge processing resource.

5. The controller arrangement of claim 1, wherein the QoS monitor is configured to estimate a current QoS of the wireless data link at runtime.

6. The controller arrangement of claim 1, any of the preceding claims, wherein the external controller is configured to perform work planning using a greater planning horizon than the robot controller.

7. The controller arrangement of claim 1, wherein the industrial robot is a mobile robot, and wherein the robot controller is an onboard motion planner.

8. The controller arrangement of claim 7, wherein the external controller is an external motion planner.

9. The controller arrangement of claim 8, wherein the external motion planner is configured to perform coordinated motion planning for the mobile robot and at least one further mobile robot.

10. The controller arrangement of claim 8, wherein the external motion planner is configured for motion planning by a model-predictive control (MPC) algorithm.

11. The controller arrangement of claim 8, wherein the onboard motion planner is configured for motion planning by a potential-field algorithm.

12. The controller arrangement of claim 8, wherein the industrial robot is a mobile robot having an arm and a base, and wherein the robot controller and/or the external controller is/are configured to control movements of the arm and horizontal motion of the base.

13. The controller arrangement of claim 1, wherein the robot controller is battery powered.

14. The controller arrangement of claim 1, wherein the QoS monitor is configured to estimate the QoS in terms of data throughput, bandwidth, packet loss rate, packet loss burstiness, transmission reliability, latency and/or latency variation.

15. A method for controlling an industrial robot that includes a robot controller and a robot manipulator, the method comprising:
maintaining a wireless data link between an external controller and the industrial robot;
controlling the industrial robot using the external controller via the wireless data link;
monitoring a quality of service (QOS) of the wireless data link; and
in response to finding that the QoS drops below a QoS threshold, temporarily controlling the industrial robot using the robot controller;
wherein monitoring the QoS includes engaging a monitoring component that is external to the industrial robot.

16. The method of claim 15, wherein the industrial robot is a mobile robot; and wherein controlling the mobile robot includes performing motion planning.

17. The method of claim 15, wherein the method is a computer-executable method embodied as computer-executable instructions stored in tangible computer media that, when executed by a computer, cause the computer to carry out the method.
